(19) United States
(12) Patent Application Publication
(10) Pub. No.: US 2019/0315476 A1
(43) Pub. Date: Oct. 17, 2019

(54) Electric Aircraft Propulsion System

(71) Applicant: Carl Eugene Lawrence, Louisville, CO (US)

(72) Inventor: Carl Eugene Lawrence, Louisville, CO (US)

(21) Appl. No.: 16/161,509

(22) Filed: Oct. 16, 2018

Related U.S. Application Data
(60) Provisional application No. 62/574,105, filed on Oct. 18, 2017.

(51) Int. Cl. B64D 27/24; B64D 33/08; B64D 31/06; B64C 11/32; H02K 5/18; H02K 11/33

(52) U.S. Cl. CPC B64D 27/24; B64D 33/08; H02K 11/33; B64C 11/32; H02K 5/18; B64D 31/06

(57) ABSTRACT

The invention relates generally to electrical propulsion of aircraft, and in particular, to electric motors that rotate propellers to produce thrust. A major challenge in electric propulsion is the thermal management of the electric motor, motor controller and battery. Conventional examples of electric aircraft place the electric motor within a cowling and connect a heat transfer system to said motor in order to move waste heat into the airstream outside of the aircraft. A streamlined electric aircraft motor and motor controller unit is disclosed, which places the waste heat generating components directly in convective thermal contact with the airstream outside of the aircraft. In order to facilitate the rapid transfer of waste heat from the motor/controller to the external airstream, the motor's electromagnets are located in a motor stator, which is external to the rotor, and thermally connected to the aerodynamically streamlined housing. The controller's power switches are similarly in contact with the housing. Said motor/controller housing, being streamlined, will transfer the waste heat to the airstream with the least amount of aerodynamic drag compared to other waste heat transfer means. Said streamlined electric aircraft motor unit will be safer and more reliable as there will be no critical secondary systems required to remove waste heat from the motor and controller.

### BACKGROUND

### Field of the Invention

The present invention relates to electric powered propulsion of aircraft, and in particular, to electric motors that rotate thrust-producing propellers.

[Nomenclature: Motor refers to electric motors and Engine refers to internal combustion engines]

### Related Art

Electric motors used in the nascent electric aircraft industry can provide thrust to propel single and multi-person aircraft. Earlier challenges related to the large size of electric motors were met with advanced high-power density motor designs, which tended to use very strong permanent magnets. Although these motors were very efficient in converting electrical energy into thrust, there were still large quantities of heat generated internally to the motors. High power density motors are generally challenged with heat build up within the motor and need either forced air or forced fluids to transfer the heat to the surrounding air through some convective means.

Although, most aircraft are designed to be aerodynamically efficient, there are design compromises associated with propulsion units' waste heat rejection. Conventional internal combustion engine aircraft have large air inlets to force air through the engine's cooling fins. This produces high aerodynamic drag losses. Some early military piston aircraft reduced these aerodynamic losses by placing liquid heat exchangers internally in contact with the aluminum skin of the aircraft wings. Loss of the cooling liquid caused by a bullet passing through the wing led to the destruction of the engine. Most small aircraft of today have streamlined cowlings covering the engine, or engines. Airflow inside of the cowlings receives a lot of scrutiny to ensure proper engine cooling.

In today's experimental electrically powered aircraft, the electric motors are placed within streamlined cowlings as are internal combustion engines. Some instances incorporate air cooling of the motors, some use a liquid cooling system and some use a combination of both air and liquid. In most cases, ram air from the forward movement of the aircraft flows into the cowling and then either around and through the electric motor or through a liquid-to-air heat exchanger. In some cases an additional electric fan is used to force more air through the propulsion motor or heat exchanger. The heated air can then exit the cowling into the external airflow.

There are losses of total aircraft energy efficiency associated with forcing air through the cowling to cool the propulsion motor and motor controller, either directly or indirectly through the heat exchanger. In many cases the total aircraft energy efficiency is improved with the use of high power density motors that use rare earth magnets for high motor efficiency. However, high power density motors generally require a liquid cooling systems, which become safety-critical components to the aircraft.

In most cases, the electrical energy efficiency of the motor is essentially the same as the electrical energy efficiency of the motor controller. And, in a similar fashion to the motor, the motor controller requires cooling. For example, a 60 kiloWatt motor may produce 3 kiloWatts of waste heat and the motor controller may also produce a few kiloWatts of waste heat.

It is critical that any electric propulsion system for aircraft be as reliable as practical. A means to this goal is to limit the number of flight critical components in the propulsion system and to include robust components and systems. A well thought-out propulsion system should not include any safety-critical liquid pumps or air fans. Also, the magnetic components of the motor should maintain their functionality at elevated temperatures. With an overall increase in aircraft energy efficiency, the propulsion system does not need to work as hard, thus increasing flight endurance and decreasing stress on the components.

### SUMMARY OF INVENTION

The disclosed invention is an electric propulsion system that provides thrust to aircraft. An electric motor spins a propeller to produce the thrust. The outer encasement or housing of the motor is streamlined and accommodates the smooth passage of air to remove heat energy produced within the motor. The housing shape and surface configuration is optimized to produce the least amount of aerodynamic drag while providing sufficient area for the transfer of the heat from said housing to the passing air. The waste heat produced within the stator of the motor is conducted from the stator into the housing and to the airstream without the use of pumps, fans or any other flight-critical components. A key feature of this invention is that the stator is contained within the housing and that the housing is directly exposed to the airstream external to the aircraft. The housing is optimized for maximum aerodynamic efficiency with streamlines from the propeller spinner passing the housing and flowing into streamlines of the aircraft. Or, in the case of a rear pusher propulsion system the airstream first passes along the aircraft, then along the housing and then passes the propeller spinner. Or, in the case of a pylon mounted propulsion system the air streamlines would start at the tip of the spinner, pass over the motor section, pass a motor controller section and then pass a battery containment section to a trailing point. The pylon mounted propulsion system could be self-contained for use on smaller aircraft such as ultra-lite aircraft, thus providing a thermally managed, aerodynamically efficient unit.

The motor industry has several terms used to indicate the housing that holds the stator in place. Frame, yoke, case, encasement and housing appear to be used interchangeably. Housing will be used in this invention disclosure to indicate the mechanical encasement that firmly captures the stator laminates and windings, and also holds the rotor bearings at each end of the motor. The stator laminates are pressed into the housing such that the housing carries the reaction torque from the stator to the airframe of the aircraft.

Unique to this invention is the use of the streamlined motor stator housing to both hold the stator and to conduct heat energy directly into the external streamlined housing for convective transfer to the passing airflow external to the aircraft. Aluminum, or another highly thermally conductive material is used for the housing.

The motor controller incorporates many heat producing components such as power transistors, MOSFETs or IGBTs. Although not essential to this invention, the heat producing components of the controller can also be placed in thermal contact with the housing as a means to manage said components' waste heat.

By the removal of any need for additional pumps and fans, the propulsion system will be safer, more reliable, and more energy efficient. The overall system can now be more compact and lighter, which are important issues for smaller aircraft.

This invention relates to motor topologies where the stator is the primary source of waste heat. It is also suggested that for a far safer and more reliable motor under extreme heat conditions, no permanent magnets be incorporated. For example, a switched reluctance motor does not use any permanent magnets and the rotor and stator are simple steel laminates. The switched reluctance motor would be a superior choice due to its much greater temperature tolerance.

It is an objective of this invention to provide an electric propulsion system for aircraft where the electric motor stator is in direct thermal connection with a thermally conductive housing that is in direct thermal connection to the passing surrounding air, where said air is moved by the propeller and where said air is passing the housing due to the forward motion of the aircraft when in motion.

It is also an objective of this invention to provide an electric propulsion system for aircraft where the electric power switching components of the motor controller are also in thermal connection to the housing for the removal of waste heat from those components.

It is an additional objective of this invention to provide a safer electric propulsion system that has no safety critical cooling systems or components.

It is a further objective of this invention to provide a more aerodynamically efficient propulsion system that is a single unit requiring only electrical power and control wiring, and is affixed directly to an aircraft mounting structure.

It is a still further objective of this invention to provide a greater temperature tolerance for the motor and the motor controller.

It is an additional further objective of this invention to provide an electric aircraft motor housing where said motor housing shape and surface finish are optimized for aerodynamic efficiency while using thermodynamic heat flow calculations to determine the required heat conduction through the housing and heat convection from the housing into the passing airstream, as required to maximize the reliability of the motor and motor controller.

### BRIEF DESCRIPTION OF THE DRAWINGS

The foregoing and other objectives, aspects and advantages of the current invention will be better understood from the detailed description of a preferred embodiment of the invention in the next section with reference to the drawings as follows:

FIG. 1. External view of propulsion system illustrating the housing, spinner, foreshortened blades of the propeller and a portion of the aircraft.

FIG. 2. Section view of propulsion system illustrating the internal components including the motor stator, motor rotor, bearings, motor controller and the housing.

FIG. 3. Schematic diagram of the propulsion system and aircraft devices and components that interface with the propulsion system.

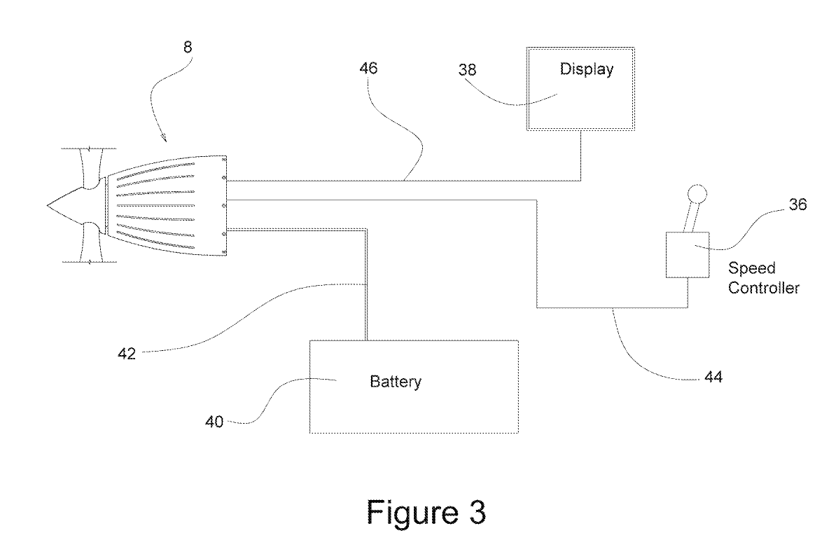

FIG. 4. Three possible configurations for pylon mounted propulsion systems, including a traction configuration, a pusher configuration and a traction/pusher combination configuration. It is to be understood that the invention is not limited in its application to the details of the particular embodiment shown, since the invention is capable of other embodiments. Also, the terminology used herein is for the purpose of description and not of limitation.

### DRAWING REFERENCE NUMBERS

propulsion system 8
motor 10
motor controller 12
motor stator 14
motor stator windings 15
motor rotor 16
housing 18
low-mass, thermally conductive material 20
aircraft 22
propeller 24
spinner 26
mounting holes 28
bearing 30
end plate 31
fins 32
controller components 34
speed controller 36
data display 38
battery 40
electric power connection 42
control connection 44
data connection 46
housing extension 48
pylon 50
traction configuration 52
pusher configuration 54
traction/pusher configuration 56

### DETAILED DESCRIPTION OF THE PREFERRED EMBODIMENT

The invention is an electric aircraft propulsion system 8, consisting of an electric motor 10, a propeller 24, and an aerodynamically streamlined housing 18. This is an improvement over the prior art as the motor stator 14 is mechanically fixed to the housing 18 and transfers the heat from the motor stator 14 directly to the ambient airstream through the thermally conductive housing 18. In this embodiment, the motor controller 12 is also contained within the streamlined housing 18. The electronic controller components 34 that produce the most waste heat within the motor controller 12 would be mounted in thermal contact to the interior surface of the housing 18, thus providing a substantial heat sink for said controller components 34.

Installation onto an aircraft 22 requires a structural mechanical mounting, an electric power connection 42 to the electrical power source or battery 40, an electrical control signal connection 44 and an electrical data connection 46 out to the aircraft 22 data display 38. An optional component within the propulsion system 8 is a drive means capable of changing the pitch of the propeller 24 as requested by the motor controller 12 or via signals from the aircraft 22 control connections 44. The propeller 24 pitch control means can be contained within the spinner 26, or can be mounted behind the motor controller 12 and actuate the propeller 24 pitch mechanism through the empty core of the motor rotor 16.

Conceptually, the electric motor can be any type of motor which has its electromagnets in an outer stator configuration. The electric current that moves through windings of electromagnets of a stator will produce heat in said windings due to resistance within the windings to electric current. Removal of waste heat is critical to the reliability and longevity of a motor. The windings produce a magnetic field in the poles of a motor stator. Said magnetic field produces a torque on a motor rotor. The rotor can contain permanent magnets, which react against said magnetic fields, as is the case with a conventional permanent magnet electric motor. Or, the rotor can be configured for a switched reluctance motor and consist of magnetic flux conducting laminates, which produce a torque by aligning with the magnetic fields from a motor stator to maximize the magnetic flux conduction. Any other motor topology which uses electromagnets in a stationary outer stator is contained within this invention, including induction motors. The preferred embodiment uses a switched reluctance motor and forgoes any permanent magnets due to safety concerns of demagnetization at high temperatures, and their availability and cost.

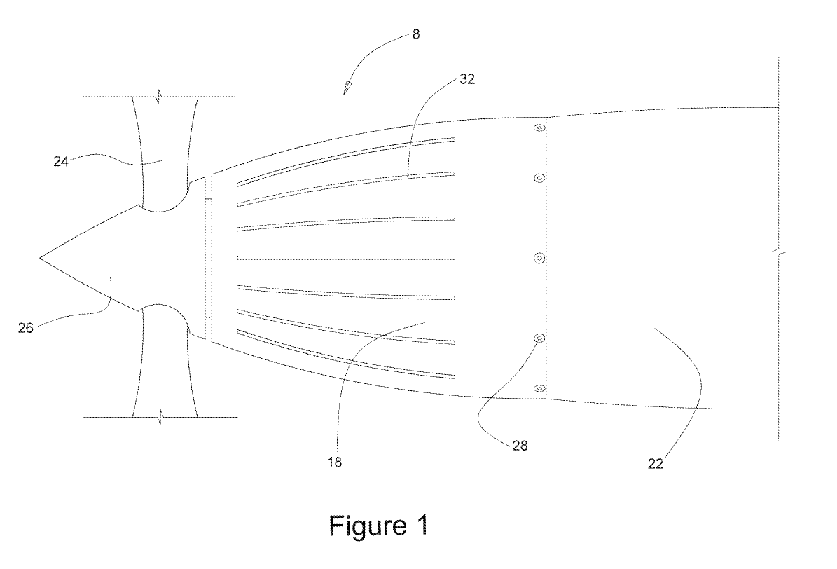

FIG. 1 is an illustration of the propulsion system 8 containing the housing 18, propeller 24, spinner 26 and a portion of the aircraft 22. All of the waste heat generated inside of the housing 18 is conducted to the outer skin of the housing 18 and transferred to the passing air. The surface area of the housing 18 can be increased with a number of fins 32, as required. A larger surface area, produced by larger and more numerous fins 32 will transfer more heat to the airstream. Heat transfer analysis calculations and finite element analysis are used to determine the optimal size, shape and number of fins 32, which add to the aerodynamic drag. More and larger fins 32 help transfer more heat, but they also add to the drag force, requiring more power, and thus, producing more waste heat. A key feature of this invention is the optimization of the streamlining of the housing 18 to produce the lowest drag while maintaining sufficient heat transfer into the ambient airflow.

A plurality of mounting holes 28 are arranged near the open end of the housing 18 to provide a means to attach the propulsion system 8 to the aircraft 22. Standard aircraft quality hardware secures the invention through the mounting holes 28 and into structural framework of the aircraft 22. The mounting hardware must withstand the torque produced by the propeller 24 against the air, the weight of the propulsion system 8, and the shock and vibration associated with landings and other activities.

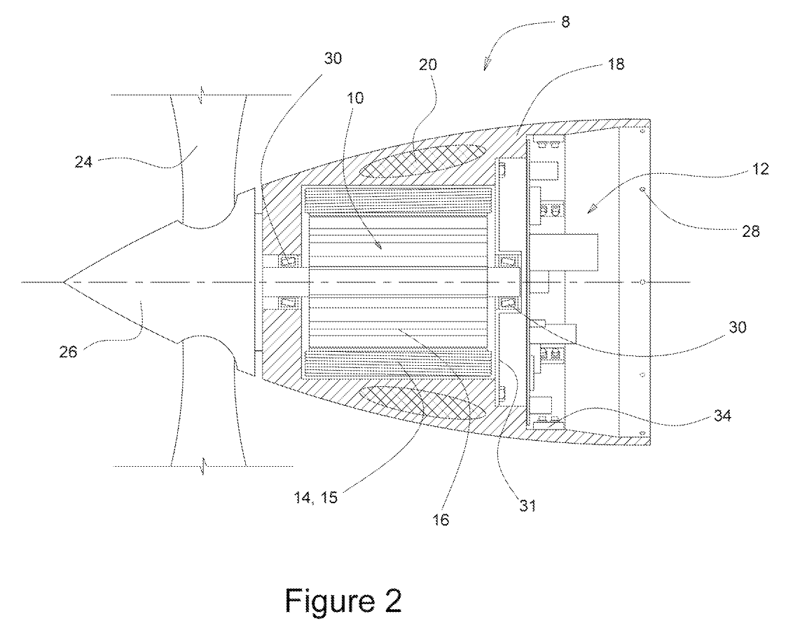

FIG. 2 is a cutaway illustration of the propulsion system 8 showing the motor 10, the motor stator 14, the motor rotor 16, the housing 18, the motor bearings 30, the foreshortened propeller 24 blades, and the spinner 26. As can be seen in this embodiment, the motor controller 12 is also mounted within extended motor housing 18. Heat generating controller components 34 are attached to the motor controller's printed circuit board and the inner surface of the housing 18. In the thicker cross-sectional areas of the housing 18, lower density, thermally conductive material 20 can be used to reduce the mass while maintaining the thermal conductivity due to the larger volume in said thicker areas. The lower density material can be produced by entrainment of voids or the substitution of other materials.

In this embodiment, the motor housing 18 is cast aluminum, although other materials such as magnesium or alloys can be used. Foamed aluminum can be used for the lower-mass, thermally conductive material 20 within the housing casting as required or desired to reduce total mass. Air or low density micro beads can be injected to also reduce the mass. In this embodiment, encapsulated foamed aluminum rings are placed in the casting mold prior to the admission of liquified aluminum. The aluminum flows around the encapsulated foamed aluminum and solidifies to produce a strong structural housing 18. Secondary manufacturing operations include machining to desired surface finishes, machining for component mounting means, and machining to exacting tolerances for the insertion of the motor stator 14 laminates. The outer surface of the housing 18 may be machined and polished to produce a surface finish with minimal microscopic irregularities in order to produce a streamlined, laminar airflow with minimal aerodynamic drag. The housing 18 may be selectively anodized, painted or plated.

The motor stator 14 laminates are pressed into the housing 18 for a permanent, interference fit. The motor stator windings 15 are either installed on the motor stator 14 before insertion into the housing 18, or after insertion into the housing 18. A bearing 30 is installed into the housing 18, which will carry one end of the motor rotor 16. The motor rotor 16 is assembled from laminates and a rotor core. The motor rotor 16 is then installed in the housing 18 and into the bearing 30. An end plate 31 with another bearing 30 installed will be installed in the housing 18 and provide a second bearing 30 support for the motor rotor 16. The end plate 31 will keep the motor rotor 16 captive. Both bearings 30 provide reaction to the gyroscopic torque produced by the propeller 24 on to the motor rotor 16, as the aircraft turns or yaws, and carry the reaction of the thrust produced my the propeller into the aircraft 22.

Controller components 34 include solid state switching devices such as IGBTs, power MOSFETs or power transistors, which are installed around the inside cylindrical surface of the housing 18. These switching devices produce waste heat and are thermally fastened to the housing 18. Thermally conductive paste is used to increase the heat transfer to the housing 18. The motor stator windings 15 are electrically connected to the controller components 34. In this embodiment there is one switching device per motor stator winding 15, although other winding to switching devices configurations are common. The motor stator windings 15 pass either through holes in the end plate 31, or around the end plate 31 through cutouts on the periphery of said end plate 31. The multiple switching devices were historically part of a separately contained motor controller, although in this embodiment said switching devices controller components 34 are physically contained within the motor housing 18 and fastened to the housing 18 as a means to remove their waste heat. The switching devices are electrically connected to the motor controller 12 and the electrical power connection 42. The electric power connection 42 between the electrical battery 40 and the switching devices controller components 34 can be through the motor controller 12 or the electric power connection 42 can bypass the motor controller 12. In this embodiment the switching devices' electrical power connections 42 are through the motor controller 12.

The motor controller 12 is a printed circuit board assembly, which contains the circuits that control the electrical current to the motor stator windings 15. Direct current is fed into the motor controller 12 and then regulated out to the motor stator windings 15. The control of the current is managed by a microprocessor or a micro-controller on the motor controller 12. The electric power connection 42 brings the direct current from the battery 40 to the motor controller 12. In other embodiments the battery could be replaced with any other source of electricity, such as a fueled generator or photovoltaic cells. The control connection 44 carries signals from a speed controller 36 to the motor controller 12. The data connection 46 carries signals from the motor controller 12 to the display 38 and to any other aircraft device that could utilize information from the motor controller 12.

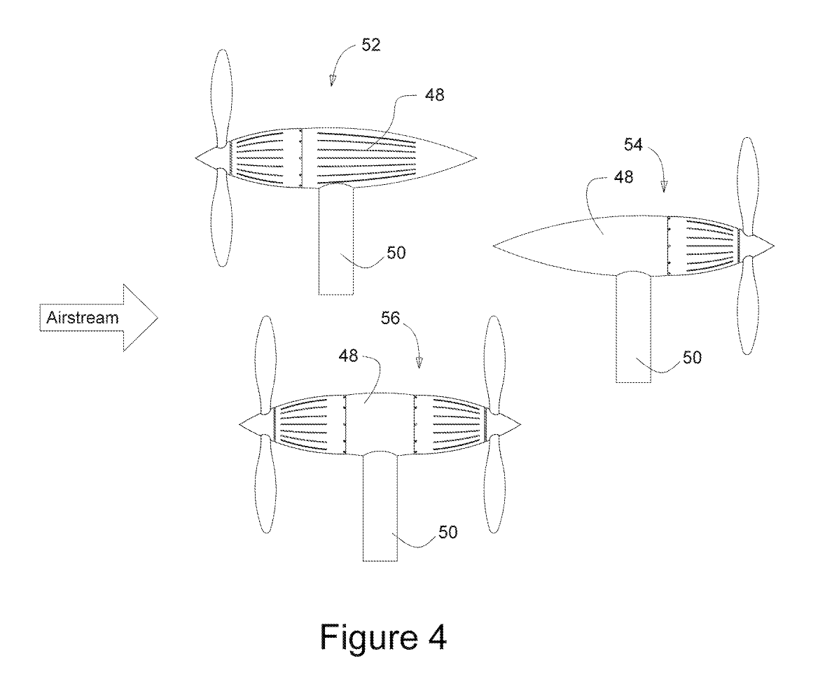

FIG. 4 illustrates some possible configurations of mounting the invention on a pylon 50, which can be attached to the airframe fuselage or empennage, or the wings of the aircraft 22. These configurations show a housing extension 48, which can be used to hold an energy storage device such as a battery 40. In traction configuration 52 the propeller 24 is pulling the aircraft 22 through the air, and the battery 40 is inside of the housing extension 48. In a similar manner to the housing 18 being aerodynamically streamlined and functioning to dissipate the heat of the motor 10, the housing extension 48 is also aerodynamically streamlined and dissipates heat from the battery 40. Pusher configuration 54 functions in the same manner as traction configuration 52 except that the propeller 24 pushes from the rear of the propulsion system 8. In pusher configuration 54 the battery 40 is in the forward portion of the propulsion system 8. A traction/pusher configuration 56 has two motors 10 with the housing extension 48 between two housings 18. The streamlined housing extension 48 contains the battery 40 and provides the mounting means to the pylon 50. The three configurations shown in FIG. 4 teach self-contained units, which hold the motor(s) 10, the motor controller(s) 12, the battery 40 in streamlined enclosures. The only connections to the aircraft 22 is the mechanical pylon 50, the control connection 44 and the data connection 46.

### Operation of the Preferred Embodiment

The invention is first installed on a prepared mount affixed to a nacelle on a wing, or to the forward end or aft end of the main airframe of the aircraft 22, or to a pylon affixed to an aircraft 22. Installation includes the electric power connection 42, the control connection 44 and data connections 46 and the mechanical fasteners that use the mounting holes 28. In this embodiment the electric power connection 42 is caused by the insertion of a high current plug into a high current receptacle of the propulsion system 8. The control connection 44 and the data connection 46 are caused by the insertion of multi-pin signal plugs into the signal receptacles of the propulsion system 8. The propulsion system 8 is then placed on the mount and secured with multiple mechanical fasteners.

Once installed, the propulsion system 8 and the aircraft systems are checked and tested to ensure that the connections were made correctly and that all systems function as expected. The speed controller 36 sends a signal to the propulsion system 8 to cause the motor 10 to rotate and spin propeller 24. The motor controller 12 translates the speed control signal to a set torque output of the motor 10. Other embodiments may use a thrust controller or power controller, for example. As additional thrust is requested by a thrust control device, the motor controller 12 delivers more electrical current to the motor 10, which then produces more thrust.

As current is fed to the motor 10 from the motor controller 12 a portion of said current is converted to waste heat in the motor stator windings 15 and in the power semiconductors 34 of the motor controller 12. The waste heat produced is proportional to the current through the components and devices. As increased current heats the motor stator windings 15 and semiconductors 34, the propeller 24 produces more thrust increasing the airflow passing the outer surface of the housing 18. In a perfect embodiment of this invention, the exact amount of additional heat produced by the increase in current is exactly removed from the outer surface of the housing 18 by the increased velocity of the air from the propeller. There will be some time lag between an increase in heat production and that heat energy's arrival at the outer surface of the housing 18. The thermal mass of the housing 18 is sufficient to sink this additional heat with a slight increase in temperature of the housing 18.

During the takeoff portion of an aircraft flight, full thrust will be requested by the speed controller 36. Full thrust generally requires the maximum available and/or useable current, producing the highest temperatures of the motor stator windings 15 and semiconductor controller components 34. A portion of this heat energy will cause the housing 18 to increase in temperature until additional airflow passing the outer surface of the housing 18 due to the forward motion of the aircraft 22 is sufficient to regulate the temperature of the housing 18. As the aircraft's 22 velocity increases, more air will pass over the outer surface of the housing 18, and transfer more heat to the ambient air. At some point in either the cruise-climb portion or the cruise portion of the flight, the temperature of the housing 18 will stabilize and then begin to decrease following a decrease in current to the motor. A certain temperature will be found where the heat flow through the housing 18 is stable for a particular power setting and atmospheric conditions. This preferred embodiment will have been engineered for a heat energy flow which would cause the semiconductor controller components 34 to maintain an optimal temperature in the cooler, ambient temperatures of the desired flight altitudes. Upon a reduction in requested thrust, the current will be reduced causing a lower heating of the motor stator windings 15 and semiconductor controller components 34, leading to a lower temperature of the propulsion system 8.

Designing the housing 18 and the low-mass, thermally conductive material 20 to have a lower temperature in the upstream airflow and higher temperature in the downstream airflow maximizes the total energy transfer by having a nearly uniform temperature difference between the housing 18 and the airstream. Since a smaller temperature difference between the housing and the air causes less energy to be transferred, the maximum energy transfer is at the greater temperature difference, thus the maximum cumulative energy transfer is with the highest cumulative temperature differences.

The heat produced in the motor stator windings 15 and controller components 34 will continue to transfer to the ambient airflow until the propulsion system 8 is powered off and cools to the ambient temperature. Since there are no additional components or systems required to transfer heat energy from the motor 10 and motor controller 12, the risk of propulsion system 8 failure due to thermal issues is essentially nonexistent. Predictable failure modes are limited to bearing 30 failures, motor controller 12 component failures and electrical shorting of the motor stator windings 15. Overall safety and reliability of the invention is anticipated to be extremely high.

### CONCLUSION, RAMIFICATION, AND SCOPE OF INVENTION

In conclusion, the disclosed invention teaches a safer and more reliable propulsion system for propeller driven aircraft. The invention has few critical components, especially as compared to internal combustion engines and other electric propulsion systems. There are no moving parts or components required to maintain propulsion system thermal management, and thus no critical points of failure in the cooling system. No other known aircraft electric propulsion system manages heat transfer through a direct thermal conductive pathway between the heat generating components and the ambient air of an aerodynamic streamlined airflow on the exterior of the propulsion system.

Aircraft energy efficiency is increased with the invention as very little energy is wasted through means to manage waste heat from the propulsion system. All waste heat is transferred to the ambient airstream through aerodynamically and convectively optimized means. There are no high drag components such as fluid-to-air heat radiators, no fans to force air into the cowling and motor, and no drag-producing air inlets directing airflow into the cowling and motor. The invention provides the shortest heat dissipation pathway to the most aerodynamically efficient and effective convective transfer means without any safety critical, secondary components.

The airflow follows streamlines along the propulsion system housing as either a laminar flow or a turbulent flow. It is anticipated that the streamlines will be laminar along the forward portion of the housing and then become turbulent at some point along the housing, and continue as turbulent for the rest of the housing. The transition point from laminar flow to turbulent flow is to be estimated by the application of the Reynolds Number. In portions of the streamlines with laminar flow the aerodynamic drag will be comparatively low, and the heat transfer will be comparatively low. After the transition to turbulent flow the aerodynamic drag will increase along with the amount of heat transfer. A compromise can be reached during the design of the housing that would predict the location of the transition between laminar flow and turbulent flow as a means to optimize the overall efficiency of the propulsion system.

Although the description above contains many specifications, these should not be construed as limiting the scope of the invention but merely providing illustrations of some of the presently preferred embodiments of this invention. Various other embodiments and ramifications are possible within the scope of this invention. Thus the scope of the invention should be determined by the appended claims and their legal equivalents, rather than by the examples given.

I claim:

1. An electric propulsion system used to provide thrust to aircraft, having a motor consisting of a rotor connected to a propeller, and a stator external to said rotor, wherein said stator is contained within and thermally connected with a streamlined housing, wherein said streamlined housing is thermally connected with an external airflow.

2. An aircraft electric propulsion system as in claim 1, where said housing is configured to transfer the heat produced by the stator such that the stator temperature is below a predetermined maximum and is uniform along the longitudinal length and circumference, and as may be required, the surface area of the housing is increased by the addition of fins.

3. An aircraft electric propulsion system as in claim 1, where said housing is configured to transfer the heat produced by the stator in a manner such that the temperature difference between the housing and airstream along the longitudinal length of the housing is uniform, and as may be required, the surface area of the housing is increased by the addition of fins.

4. An aircraft electric propulsion system as in claim 1, where said housing is configured to transfer the heat produced by the motor in a manner such that the temperature along the longitudinal length of the housing increases in the direction of airflow, in sync with the increase in the temperature of the airflow, minimizing the cumulative differences in temperatures between the housing and the air.

5. An aircraft electric propulsion system as in claim 1, where a motor controller incorporates electrical power switching semiconductors controller components, which are mechanically fixed and thermally conductive to said housing for the purpose of dissipating the heat of said semiconductors.

6. An aircraft electric propulsion system as in claim 1, where said propeller incorporates blades that are adjusted in pitch by means of a mechanical actuator driven by an electrical means.

7. An aircraft electric propulsion system as in claim 1, where the inner volume between the streamlined housing and the stator incorporates a low-mass, thermally conductive material in predetermined regions.

8. An aircraft electric propulsion system consisting of an electric motor, which has an external stator mechanically fixed and thermally conductive to a streamlined housing, a rotor internal to said motor, a propeller fixed to said rotor and a spinner affixed to said propeller; wherein said housing is configured to continue aerodynamic flow lines from said spinner and to a mounting nacelle on said aircraft.

9. An aircraft electric propulsion system as in claim 8, where the inner volume between the streamlined housing and the stator incorporates a low-mass, thermally conductive material in predetermined regions.

10. An aircraft electric propulsion system as in claim 8, where a housing extension is fixed to said housing and contains a battery to provide energy to said propulsion system.

11. An aircraft electric propulsion system as in claim 8, where a housing extension is fixed to said housing and provides a mounting means to a pylon affixed to said aircraft.

12. An aircraft electric propulsion system as in claim 8, where a housing extension is fixed to said housing and provides a mounting means for an additional propulsion system.
